(19) United States
(12) Patent Application Publication
(10) Pub. No.: US 2013/0034441 A1
(43) Pub. Date: Feb. 7, 2013

(54) MULTIPLE-LAYER STRUCTURE OF INFLATABLE DEVICE CAPABLE OF PRESSURE RESISTANCE

(71) Applicants: Xiao Ming Jin, Bangkok (TH); Tao Jin, Xian City (CN); Henry Lam, Narwee (AU)

(72) Inventors: Xiao Ming Jin, Bangkok (TH); Tao Jin, Xian City (CN); Henry Lam, Narwee (AU)

(73) Assignees: Xiao Ming Jin, Bangkok (TH); Henry Lam, Narwee (AU); Tao Jin, Xian City (CN)

(21) Appl. No.: 13/197,724

(22) Filed: Aug. 3, 2011

(51) Int. Cl. F03D 11/00

(52) U.S. Cl. 416/84

(57) ABSTRACT

A multiple-layer structure of inflatable device capable of pressure resistance includes a gasbag unit and a reinforcing shape-forming net. The gasbag unit includes a gas inlet, a flexible waterproof inner tube for fluid communication with the gas inlet, and a flexible material of outer tube covering the flexible waterproof inner tube, wherein the gasbag unit and the reinforcing shape-forming net covering the gasbag unit are both in independent structures. When the gasbag unit become expanded over the reinforcing shape-forming net, the reinforcing shape-forming net will resist the applied force from the gasbag unit, so that the gasbag unit can be made of a light weight material and thus the maintenance and renew become easy. The present invention is not only easy in maintenance but also efficiently reducing cost for all kinds of inflatable products and environment protection.

### FIELD OF THE INVENTION

The present invention relates to an inflatable means, and more particularly to a multiple-layer structure of inflatable device capable of pressure resistance with gasbag thereof.

### BACKGROUND OF THE INVENTION

Air is an inexhaustibly safe energy without pollution. There are a lot of inflatable products, e.g. large inflatable advertising product, inflatable toy, inflatable boat, inflatable mattress, inflatable sofa, and so forth in the market. However, the existing inflatable products are all only with a structure of single-layer gasbag, which is generally made of expensive PVC composite material in order to enhance its pressure resistance and compression strength. The PVC composite material has advantages of air tightness, long life of service life, and so on, but it needs mass amount of solvents to disintegrate the PVC composite material for recycle, and it thus leads to a chain of environment pollution. In addition, if also the high price of such PVC composite material and difficulty of maintenance for its thick in thickness and heavy weight are in consideration, it is understood that such PVC composite material can not meet the requirement of energy save and environment protection for a modern world.

Furthermore, wind power is a kind of excellent renewable energy if the concept of environment protection is considered. The conventional wind blade is generally made from mixed composite material including carbon-fiber-rein forced plastic (CFRP), carbon fiber (CF), or glass fiber (GF). When a fixed wind speed or a fixed wind power is considered, the weight and a frontal area of the wind blades will directly affect the efficiency of power generation. As a result, choosing a kind material of wind blade with lighter weight or designing a better structure of the wind blade has became the main points in the field. However, the existing material not only has the drawback of its heavy weight and hard for being shaped to thus directly affect the efficiency of power generation, but also has the drawback of its high cost in production. Thus, the existing material can not be satisfied the need for energy save and environment protection for a modern world too.

### SUMMARY OF THE INVENTION

Thereby, an object of the present invention is to provide a multiple-layer structure of inflatable device capable of pressure resistance that overcomes the defects existing in the prior arts.

Another object of the present invention is to provide a multiple-layer structure of inflatable device capable of pressure resistance having a wind blade structure, which has the advantages of material save and light weight to thus greatly enhance the efficiency of wind power.

The present invention overcomes the drawbacks of the prior art, and provides a multiple-layer structure of inflatable device capable of pressure resistance, which comprises a gasbag unit and a reinforcing shape-forming net. The gasbag unit includes a gas inlet and a flexible waterproof inner tube for fluid communication with the gas inlet. The reinforcing shape-forming net covers the gasbag unit, wherein a volume of the inflated gasbag unit is larger than an area covered by the reinforcing shape-forming net.

In a preferred embodiment of the present invention, the gasbag unit includes a flexible material of outer tube covering the flexible waterproof inner tube, and a volume of the inflated flexible waterproof inner tube is larger than a volume of the flexible material outer tube.

In a preferred embodiment of the present invention, the gasbag unit further includes a backup waterproof inner tube provided between the flexible waterproof inner tube and the reinforcing shape-forming net.

In a preferred embodiment of the present invention, the gasbag unit further includes a backup waterproof inner tube provided between the flexible waterproof inner tube and the flexible material of outer tube.

In a preferred embodiment of the present invention, the gasbag unit includes at least two gas inlets.

In a preferred embodiment of the present invention, the gasbag unit is a tubular gasbag curved and provided within the reinforcing shape-forming net, two ends of the tubular gasbag are provided with two gas inlets respectively, and a connecting member is disposed between the gas inlets, and a air-connecting pipe is provided at a gap of the curved gasbag unit.

In a preferred embodiment of the present invention, the gasbag unit is composed of at least two tubular gasbags connecting with each other and curved and provided within the reinforcing shape-forming, two ends of each of tubular gasbags are provided with both gas inlets respectively, and an anti-dislocation retaining cover is provided between the two tubular gasbags.

In a preferred embodiment of the present invention, the reinforcing shape-forming net includes an upper net frame, a lower net frame and a plurality of pulling cords connected between the upper net frame and the lower net frame, wherein one of the pulling cords has an end thereof connected between the upper net frame and the lower net frame, and the other end of the pulling cords is connected between the upper net frame and the lower net frame by a releasable fastener.

In a preferred embodiment of the present invention, wherein a hard material board is provided corresponding to an area of the lower net frame, and the hard material board has holes corresponding to the respective pulling cord between the upper net frame and the lower net frame.

In a preferred embodiment of the present invention, the gasbag unit is composed of a connecting cloth and a slit opening for allowing the connecting cloth to pass through the slit opening.

In a preferred embodiment of the present invention, the gasbag unit, which is a transparent cavity gasbag, is provided at an end thereof with a combining hole for allowing a light-emitting unit to be inserted and the other end thereof with a mirror plane corresponding to the combining hole.

In a preferred embodiment of the present invention, wherein the gasbag unit is a transparent conical cavity gasbag, the strengthening and fixing net includes a separating net and a light-reflecting member positioned in a predetermined portion thereof, the gasbag unit is provided over the separating net of the reinforcing shape-forming net, and a hard material base is provided below the separating net of the same.

In a preferred embodiment of the present invention, the gasbag unit further includes a connecting hole formed along a center axis direction for allowing a warning lamp to be inserted.

In a preferred embodiment of the present invention, the gasbag unit is a wind blade shape cavity gasbag for covering on a wind blade device having a rotating shaft and a plurality of wind blades connected with the rotating shaft.

In a preferred embodiment of the present invention, the flexible waterproof inner tube is a modeling inner tube and the flexible material outer tube is made from a chemical fiber (nylon) fabric and/or the fabric threads, and the reinforcing shape-forming net is made of one or the combination of a natural material, a metallic material, a plastic material, a nano material, a fiberglass material and a chemical fiber (nylon) material.

Furthermore, in another preferred embodiment that the present invention overcomes the drawbacks of the prior art, and provides a multiple-layer structure of inflatable device capable of pressure resistance, which comprises a gasbag unit including a gas inlet, a flexible waterproof inner tube fluid connected with the gas inlet, and a flexible material of outer tube covering the flexible waterproof inner tube, wherein a volume of the inflated flexible waterproof inner tube is larger than a volume of the flexible material of outer tube, wherein the gasbag unit is a gas multi-pole structure; a reinforcing shape-forming net covering the gasbag unit, wherein a volume of the inflated gasbag unit is larger than an area covered by the reinforcing shape-forming net.

In another preferred embodiment of the present invention, the flexible waterproof inner tube is a modeling inner tube and the flexible material outer tube is made from a chemical fiber (nylon) fabric and/or the fabric threads.

In another preferred embodiment of the present invention, the reinforcing shape-forming net is composed of a plurality of partitioning members.

In another preferred embodiment of the present invention, the reinforcing shape-forming net is provided with the holes and a pulling cord passing through the holes, and both ends of the pulling cord are fixed to each other.

The gasbag unit, when inflated, is bigger than the reinforcing shape-forming net, so that the reinforcing shape-forming will resist the force applied to the gasbag unit. The gasbag unit may be made of light weight material and can be replaced with a new one if damaged. It greatly overcomes the defect of a prior art in which an inflatable product made of a single-layer composite material is hard to recycle. Further, the structure of the reinforcing shape-forming net is stronger and easier to form the shape without being limited to its air-tightness in material. It makes the utilization of the product more flexible by combination between or among the utilization of gasbag and gasbag or gasbag and hard material member.

Furthermore, when a wind speed or a wind power of a wind power generator is considered as constant values, it is found that a weight and a frontal area of the wind blades will directly affect the efficiency of power generation. The wind blades, which do not need a rigid structure as that required in aerofoil, allow the elasticity in some degree so as to be rotated by the wind force. Therefore, the wind blades of the present invention can be used for compact wind power generator even at low wind speed or at roof in limited land resources such as in the city. When the gasbag unit of the present invention is covered on a wind blade of a conventional wind power generator and is inflated with helium gas, the total weight will be much less and the frontal area will be larger than conventional one, so that power generation efficiency thereof can be improved. Furthermore, if the air in the gasbag unit is allowed to be expelled in advance of the typhoon, it will elongate the time duty of the device. In addition, a cheaper modeling material may be used as the inner tube in the present invention, so that the inner tube can be replaced with a new cheap one when aged or damaged.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a perspective view illustrating the first embodiment according to the present invention;

FIG. 2 is a perspective view illustrating the second embodiment according to the present invention;

FIG. 3 is a sectional perspective view illustrating the second embodiment according to the present invention;

FIG. 4 is a perspective view illustrating the strengthening and fixing net according to the present invention;

FIG. 5 is a perspective view illustrating the third embodiment according to the present invention;

FIG. 6 is a perspective view illustrating the fourth embodiment according to the present invention;

FIG. 7 is an exploded view illustrating the fourth embodiment according to the present invention;

FIG. 8 is a perspective view illustrating the fifth embodiment according to the present invention;

FIG. 9 is a perspective view illustrating the sixth embodiment according to the present invention;

FIG. 10 is a perspective view illustrating the seventh embodiment according to the present invention;

FIG. 11, FIG. 12 and FIG. 13 are the perspective views illustrating the eighth embodiment according to the present invention;

FIG. 14 and FIG. 15 are the perspective views illustrating the ninth embodiment according to the present invention.

### DETAILED DESCRIPTION OF THE PREFERRED EMBODIMENTS

### The First Embodiment

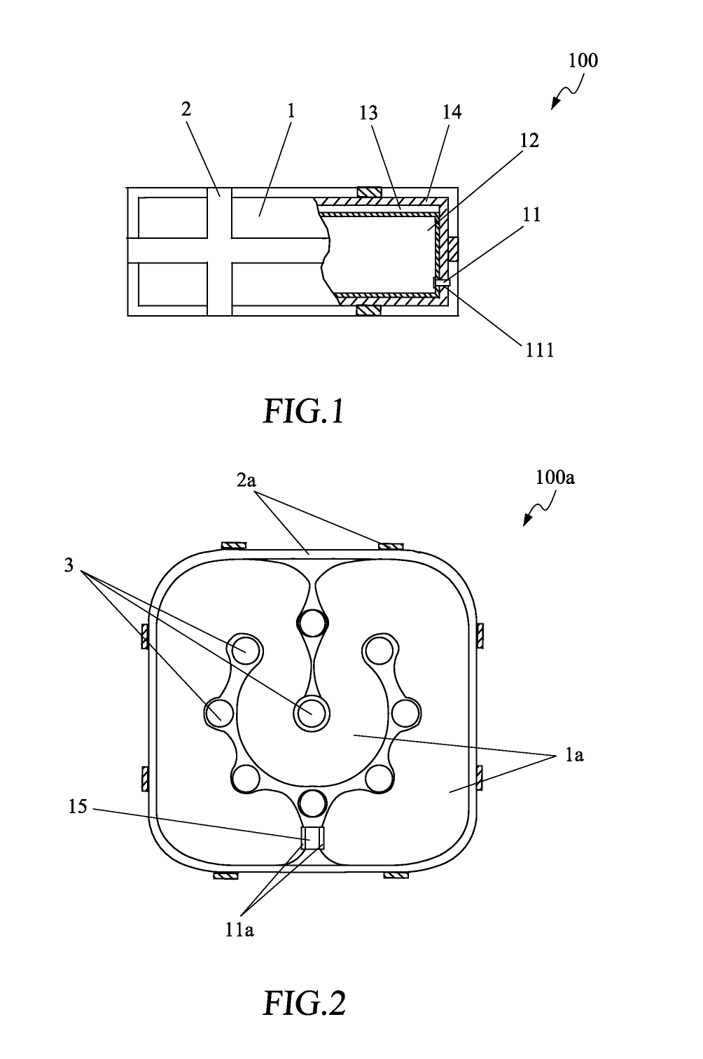

A multiple-layer structure of inflatable device capable of pressure resistance 100 of the present invention is a square shape of inflatable cushion as shown in FIG. 1. The multiple-layer structure of inflatable device capable of pressure resistance comprises a gasbag unit 1 and a reinforcing shape-forming net 2. The gasbag unit 1 includes a gas inlet 11, flexible waterproof inner tubes 12, 13 which are in fluid communication with the gas inlet 11, and a flexible material of outer tube 14 covering the flexible waterproof inner tube 12, wherein the flexible waterproof inner tube 12 and the flexible waterproof inner tube 13 are with the substantially same size and are both shaped as square modeling inner tubes. The flexible material of outer tube 14, which can accommodate the flexible waterproof inner tube 12 and 13, is a heavy-duty fabric outer tube. The reinforcing shape-forming net 2 is made from a chemical fiber (nylon) material. The flexible material of outer tube 14 is provided with an opening hole 111 for allowing the gas inlet 11 extending.

In this embodiment, the flexible waterproof inner tube 13 is a backup waterproof inner tube, wherein a volume of each inflated flexible waterproof inner tube 12 or 13 is larger than that of the flexible material of outer tube 14. And a volume of each inflated flexible waterproof inner tube 12 or 13 is larger than an area covered by the rein forcing shape-forming net 2.

The flexible waterproof inner tube 12 or 13 provided within the flexible material of outer tube 14 can be of any arbitrary shapes. Since the flexible waterproof inner tube 12 and 13 are limited and covered by the flexible material of outer tube 14, the flexible waterproof inner tube 12 or 13 will not be blew out due to the over inflation.

The reinforcing shape-forming net 2 can reinforce the whole strength of structure for the inflated gasbag unit 1, and also can prevent the gasbag unit 1 from over deformation due to external over pressure. It thus thereafter enhances the robustness of the multiple-layer structure of inflatable device capable of pressure resistance 100 of this embodiment as a cushion.

Herein as an example, the flexible waterproof inner tube 13 as a backup inner tube is provided between the flexible material of outer tube 14 and the inflated flexible waterproof inner tube 12. The flexible waterproof inner tube 13 may be immediately replaced in use as soon as the flexible waterproof inner tube 12 was broken so as to keep the inflatable device properly function.

### The Second Embodiment

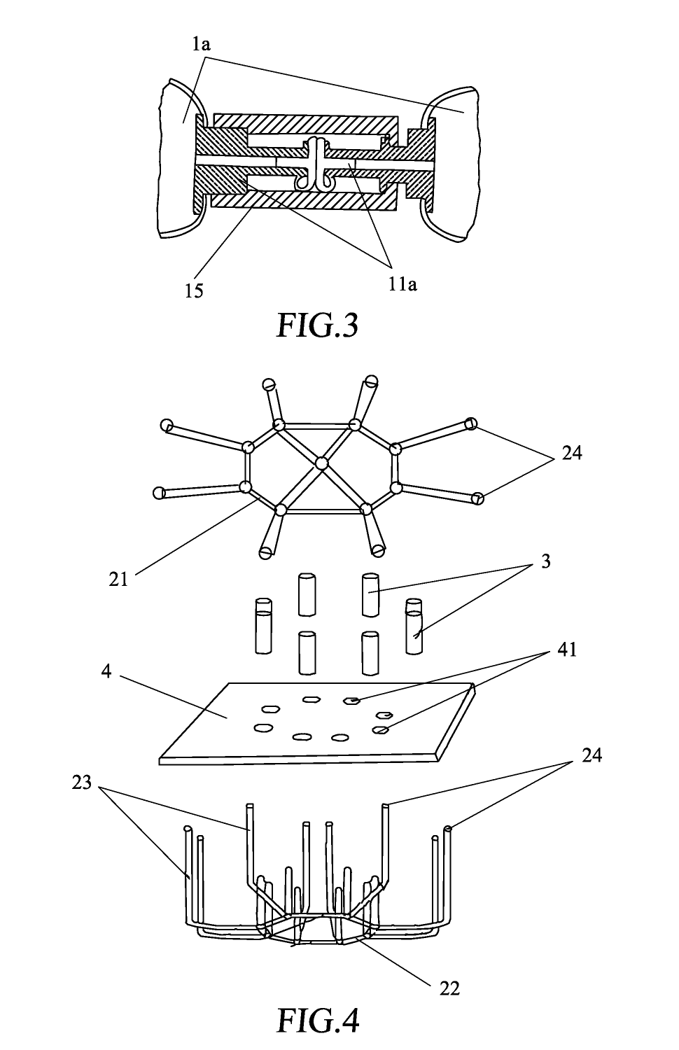

A multiple-layer structure of inflatable device capable of pressure resistance 1000a of the present invention is also a square inflatable cushion as shown in FIG. 2 to FIG. 4. The elements of this embodiment illustrated in these three Figs. are similar to those in the first embodiment. The second embodiment is different from the first embodiment in as follows. The gasbag unit 1a is a tubular gasbag which are curved and located within the reinforcing shape-forming net 2a. The two ends of gasbag unit 1a are provided with a gas inlet 1a respectively. A screwed connecting member 15 is disposed for connecting both of gas inlets 11a.

In this embodiment, an air-connecting pipe 3 is perpendicularly provided within the gaps between the curved gasbag unit 1a. The length of the air-connecting pipe 3 is smaller than the height of the full-inflated gasbag unit 1a. The air-connecting pipe 3 is used for the air communication for the multiple-layer structure of inflatable device capable of pressure resistance 100a as an inflatable cushion.

The reinforcing shape-forming net 2a as shown in FIG. 4 includes an upper net frame 21, a lower net frame 21 and a plurality of pulling cords 23 connected between the upper net frame 21 and the lower net frame 22. One end of the pulling cords 23 connects with the upper net frame 21 and the lower net frame 22, and the other end thereof connected between the upper net frame 21 and the lower net frame 22 via a releasable fastener 24. Each of the air-connecting pipes 3 is covered on each corresponding pulling cords 23. The described releasable fastener 24 may be a button, a cord fastener, etc.

In order to enhance the steadiness of the inflatable cushion, a hard material board 4 is provided corresponding to an area of the lower net frame 22. The hard material board 4 has holes 41 respectively provided to each corresponding pulling cords 23 between the upper net frame 21 and the lower net frame 22.

### The Third Embodiment

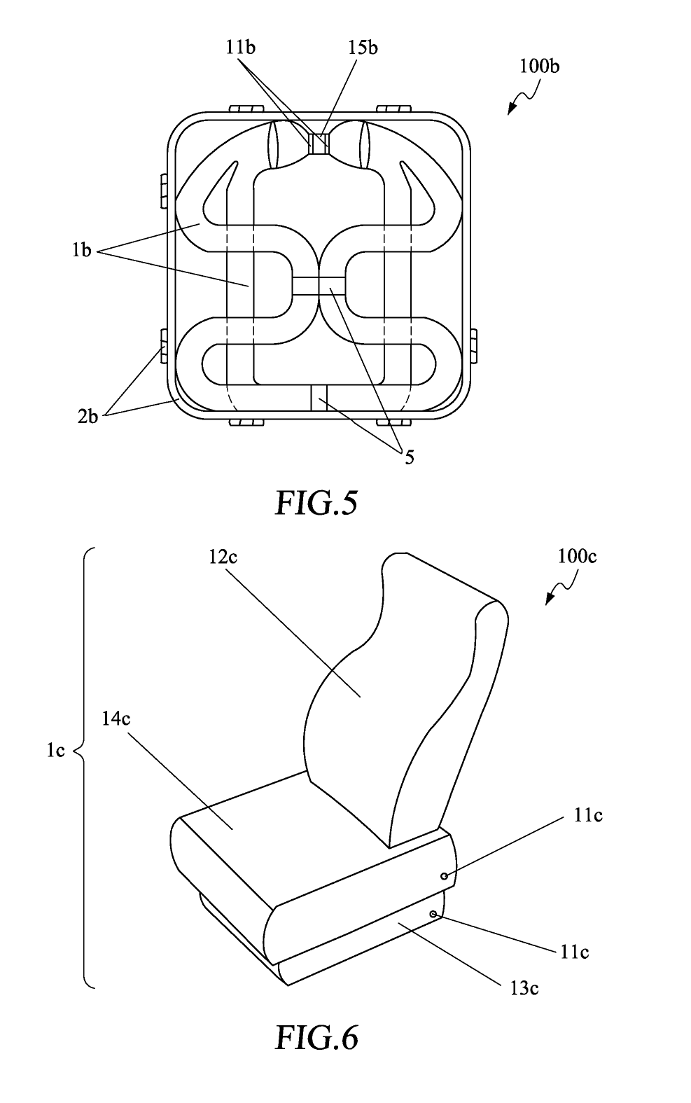

A multiple-layer structure of inflatable device capable of pressure resistance 100b of the present invention is also a square inflatable cushion as shown in FIG. 5. The elements of this embodiment illustrated in this Fig. are similar to those in the second embodiment. The third embodiment is different from the second embodiment in as follows. The gasbag unit 1b is composed of two tubular gasbags connecting with each other. Two tubular gasbags are curved and covered by reinforcing shape-forming net 2b. Two ends of each tubular gasbag are respectively provided with a gas inlet 11b, and a screwed connecting member 15b is disposed between respective gas inlets 11b of two tubular gasbags. An anti-dislocation retaining cover 5 is provided between the two tubular gasbags to prevent any dislocation between the two tubular gasbags which are curved to locate.

### The Fourth Embodiment

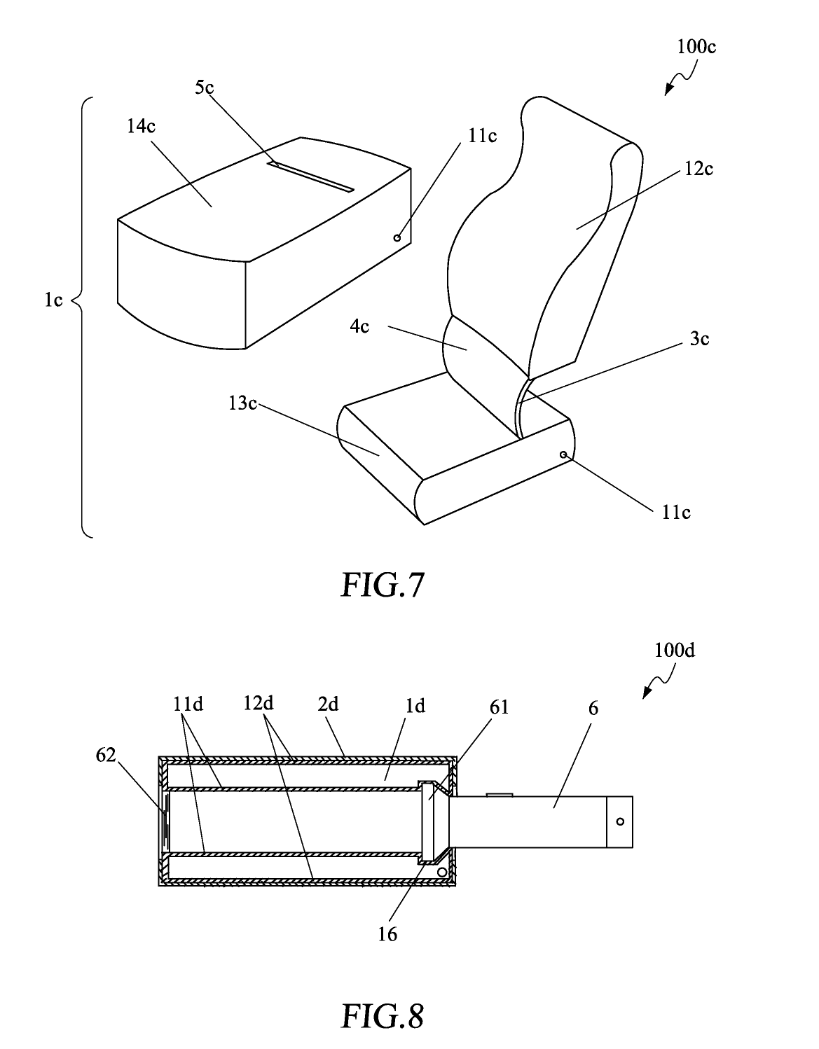

A multiple-layer structure of inflatable device capable of pressure resistance 100c of the present invention is an inflatable backrest chair as shown in FIG. 6 and FIG. 7.

The gasbag 1c includes a backrest gasbag 12c, a seat gasbag 13c and a cushion gasbag 14c. The backrest gasbag 12c and the seat gasbag 13c are connected with the cushion gasbag 14c by means of the connecting cloth 4c. The gas inlets 11c are respectively provided on the seat gasbag 13c and the cushion gasbag 14c. The connecting cloth 4c is provided with a air connecting pipe 3 for fluid communication between the backrest gasbag 12c and the seat gasbag 13c. The cushion gasbag 14c is provided with a slit opening 5c with a width same as the width of the connecting cloth 4c for allowing the backrest gasbag 12c and the connecting cloth 4c to pass through. The reinforcing shape-forming net 2b which is made from a chemical fiber (nylon) material covers the backrest gasbag 12c, the seat gasbag 13c and the cushion gasbag 14c.

The multiple-layer structure of inflatable device capable of pressure resistance 100c of this embodiment is used as an inflatable backrest chair, the arrangement of which is provided with the backrest gasbag 12c, the connecting cloth 4c and the cushion gasbag 14c to supply a stable backrest chair. In this embodiment, it is disassembled to become a simple bed. When not in use, it just leaks out the gas and folds to allow an easy storage.

### The Fifth Embodiment

A multiple-layer structure of inflatable device capable of pressure resistance 100d of the present invention is a lamp with an anti-vibration inflatable lamp cover as shown in FIG. 8.

The gasbag unit 1d, which is a transparent cavity gasbag, is covered outside thereof with a reinforcing shape-forming net 2d made from a chemical fiber (nylon) material. It is provided at an end of the gasbag unit 1d with a connecting hole 16 for allowing such as a lamp head 61 of a light-emitting unit 6 to insert. The other end of the gasbag unit 1d is provided with a mirror plane 62 corresponding to the connecting hole 16. The mirror plane 62 faces toward the lamp head. This structure allows the light inflects to an inner side 11d of the gasbag unit 1d and then transmits to an outer side 12d of the gasbag unit id, so that the gasbag unit 1d becomes a light-emitting body.

The gasbag unit 1d covered on the light-emitting unit 6 enhances the light concentration and advances light illumination. The inflated gasbag unit 1d also can protect the lamp head 61 of the light-emitting unit 6 from damage due to vibration or strike. When not in use, it just leaks out the gas in the gasbag unit 1d, and then folds up the gasbag unit 1d, so as to minimize the multiple-layer structure of inflatable device capable of pressure resistance 100d of the present invention. It thus is suitable for carrying and used as a night warning device.

### The Sixth Embodiment

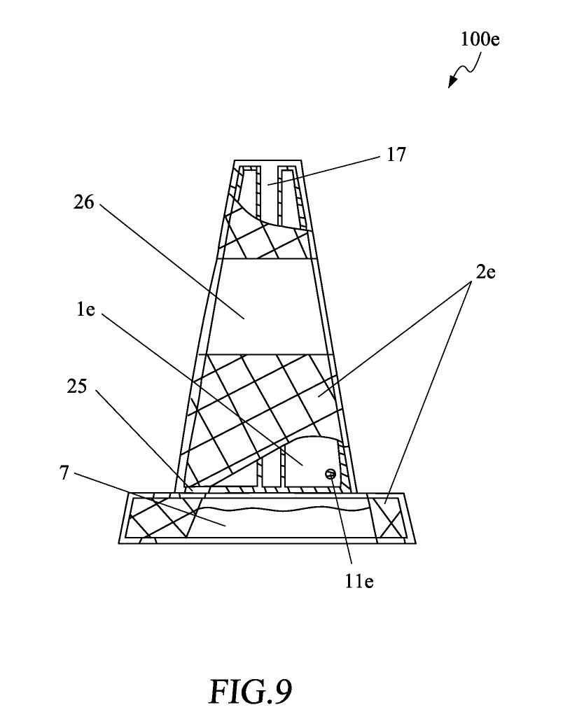

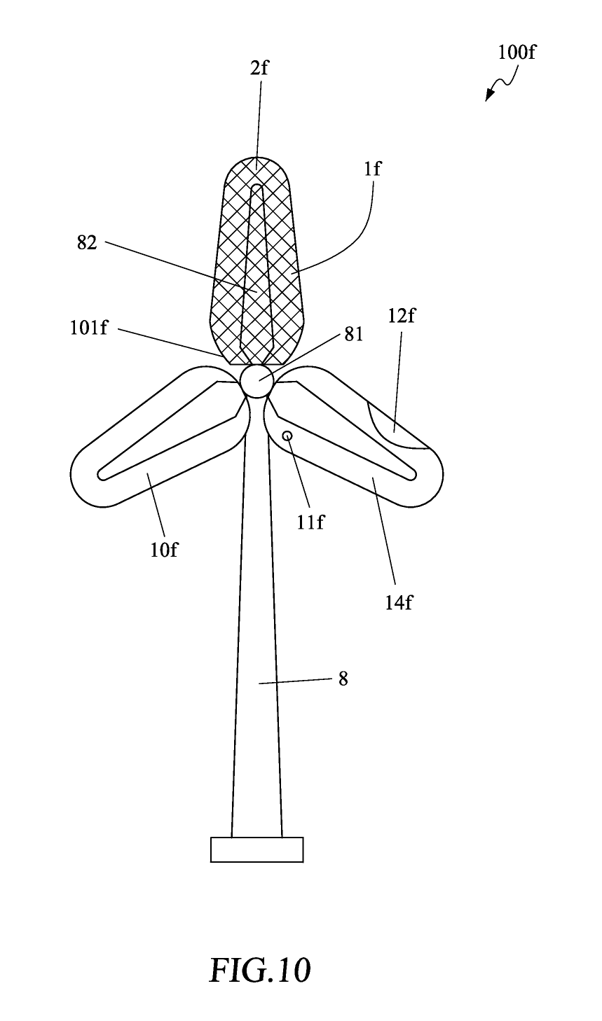

A multiple-layer structure of inflatable device capable of pressure resistance 100e of the present invention is a portable light-emitting warning road cone as shown in FIG. 9.

In this embodiment, the gasbag unit 1e is a transparent conical cavity gasbag with a gas inlet 11e. The reinforcing shape-forming net 2e includes a separating net 25 and a light-reflecting member 26 positioned in a predetermined portion of the reinforcing shape-forming net 2e. The gasbag unit 1e is provided over the separating net 25 of the reinforcing and fixing net 2e, and a hard material base 7 is provided below the separating net 2e of the same.

Further, the gasbag unit 1e further includes a connecting hole 17 formed along a center axis direction for allowing a warning lamp to be inserted.

### The Seventh Embodiment

A multiple-layer structure of inflatable device capable of pressure resistance 100f of the present invention is installed on a wind blade device 8 as shown in FIG. 9. The wind blade device 8 comprises a rotating shaft 81 and a plurality of wind blades 82 connected with the rotating shaft 81. The multiple-layer structure of inflatable device capable of pressure resistance 100f comprises a gasbag unit if and a reinforcing shape-forming net 2f covering the gasbag unit 1f. The gasbag unit if includes a plurality of air jackets 10f, and each of the air jackets is covered correspondingly on the wind blade 82, wherein the air jacket 100f has a jacket port 101f, a gas inlet 11e for fluid communication with the jacket port 101f, a flexible waterproof inner tube 12f for fluid communication with the gas inlet 11e, and a flexible material of outer tube 14f covering the flexible waterproof inner tube 12f. The structure thus extends the overall length of the wind blade and increases a frontal area of the same. In addition, a volume of the inflated flexible waterproof inner tube 12f is larger than that of the flexible material outer tube 14f. And a volume of each inflated flexible waterproof inner tube 12f or 13f is larger than an area covered by the reinforcing shape-forming net 2f.

### The Eighth Embodiment

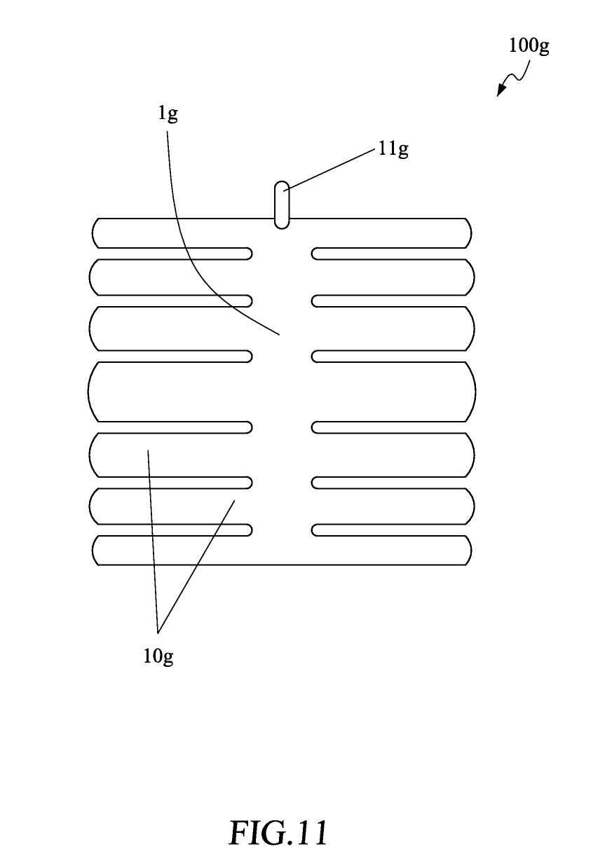

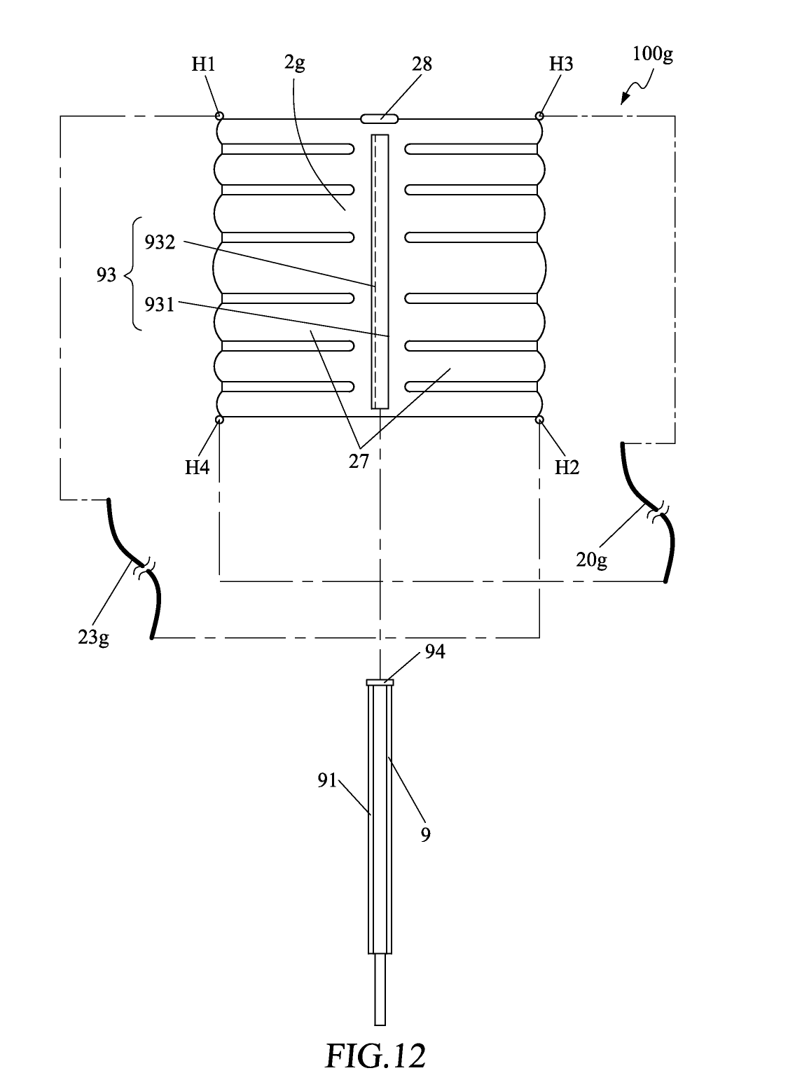

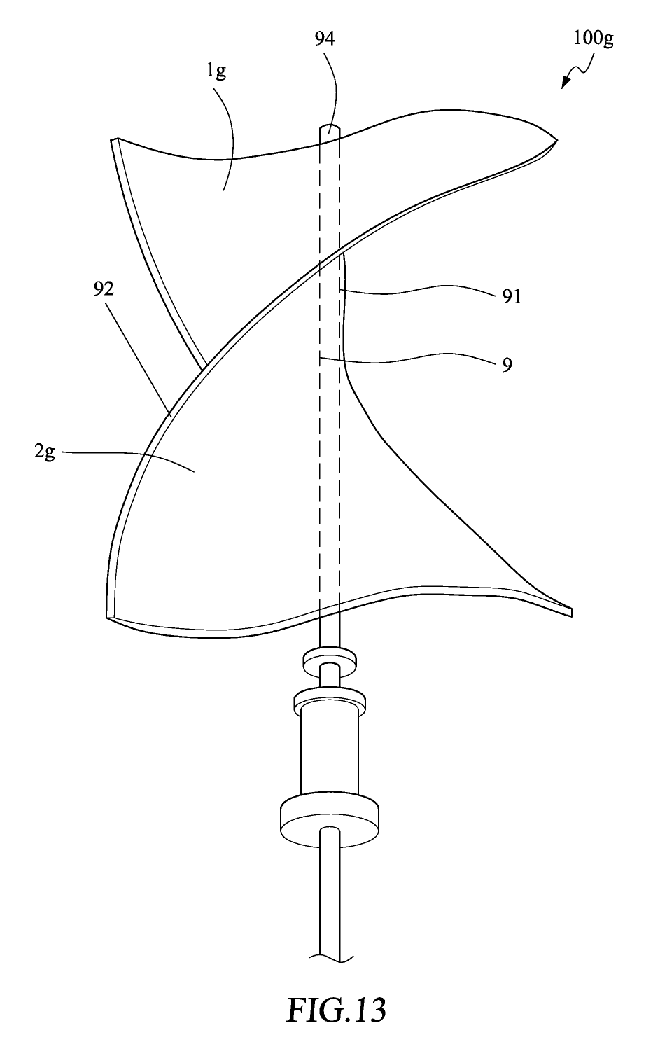

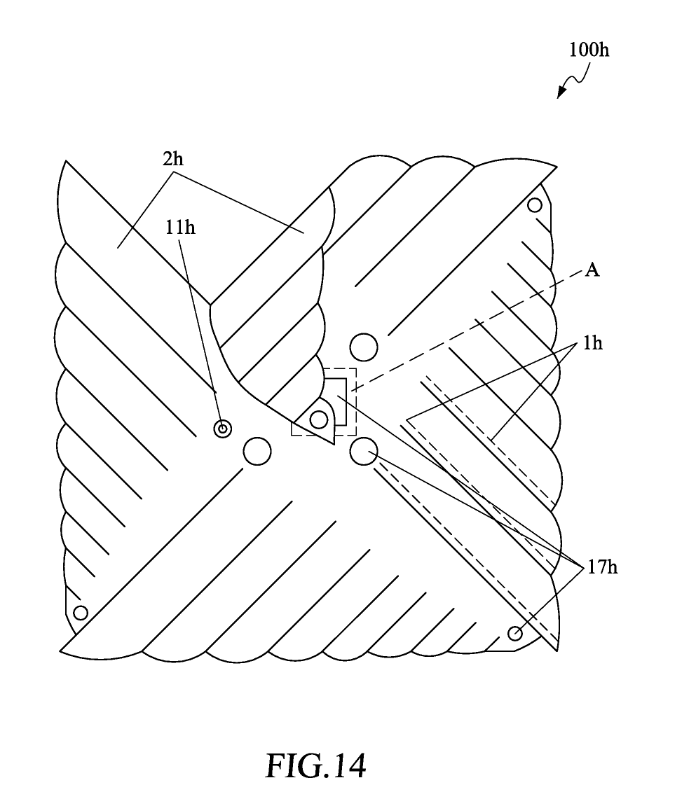

A gasbag unit 1g of a multiple-layer structure of inflatable device capable of pressure resistance 100g includes an air jacket 10g and a gas inlet 11g as shown in FIG. 11 to FIG. 13. The air jacket 10g is covered on a wind blade 92 of a wind blade device 9, and a rotating shaft 91 of the wind blade device 9 is provided with a through hole member 93 for allowing a power unit (not shown) to be installed, wherein the through hole member 93 is composed of both through holes 931, 932, which are provided on a reinforcing shape-forming net 2g having a sealing end 28 and a partitioning member 27.

The through holes 931, 932 are provided on the rotating shaft 91 of the wind blade device 9 for allowing a shaft rod 94 to insert. The reinforcing shape-forming net 2g is provided with holes H1, H2, H3, H4 and the pulling cords 20g, 23g, wherein the pulling cords 23g can pass through both holes H1, H2, so that both ends of the pulling cords 23g are fixed to each other, and the pulling cords 20g can pass through both holes H3, H4, so that both ends of the pulling cords 2g are fixed to each other to form as illustrated.

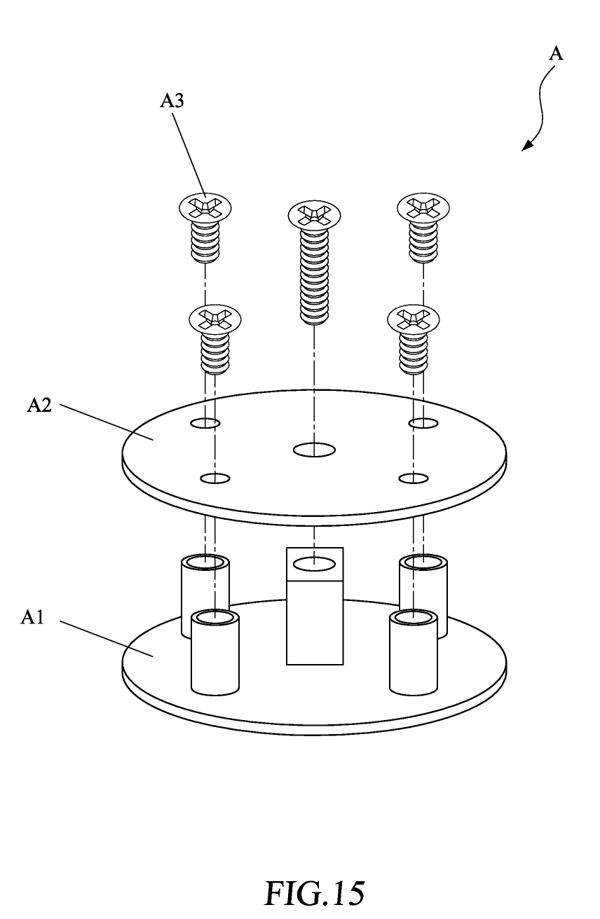

Furthermore, in other embodiments, a multiple-layer structure of inflatable device capable of pressure resistance 100h of the ninth embodiment of the present invention is applied to a wind blade device as shown in FIG. 14 and FIG. 15. The multiple-layer structure of inflatable device capable of pressure resistance 100h comprises a gasbag unit 1h with a gas inlet 11h and a reinforcing shape-forming net 2h covering with the gasbag unit 1h. The multiple-layer structure of inflatable device capable of pressure resistance 100h of the present invention is provided with a connecting hole for covering on a strengthening disc A, which allows a power unit to be installed (not shown), wherein the strengthening disc A is composed of a strengthening disc base A1, a strengthening disc cover A2 and a plurality of screws.

As can be appreciated from the above embodiments, the multiple-layer structure of inflatable device capable of pressure resistance of the present invention has industry worth which meets the requirement for a patent. The above description should be considered as only the discussion of the preferred embodiments of the present invention. However, a person skilled in the art may make various modifications to the present invention. Those modifications still fall within the spirit and scope defined by the appended claims.

What is claimed is:

1. A multiple-layer structure of inflatable device capable of pressure resistance, comprising:
a gasbag unit including a gas inlet and a flexible waterproof inner tube for fluid communication with the gas inlet; and
a reinforcing shape-forming net covering the gasbag unit, wherein a volume of the inflated gasbag unit is larger than an area covered by the reinforcing shape-forming net.

2. The multiple-layer structure of inflatable device capable of pressure resistance as claimed in claim 1, wherein the gasbag unit includes a flexible material of outer tube covering the flexible waterproof inner tube, and a volume of the inflated flexible waterproof inner tube is larger than a volume of the flexible material outer tube.

3. The multiple-layer structure of inflatable device capable of pressure resistance as claimed in claim 1, wherein the gasbag unit further includes a backup waterproof inner tube provided between the flexible waterproof inner tube and the reinforcing shape-forming net.

4. The multiple-layer structure of inflatable device capable of pressure resistance as claimed in claim 2, wherein the gasbag unit further includes a backup waterproof inner tube provided between the flexible waterproof inner tube and the flexible material of outer tube.

5. The multiple-layer structure of inflatable device capable of pressure resistance as claimed in claim 2, wherein the gasbag unit includes at least two gas inlets.

6. The multiple-layer structure of inflatable device capable of pressure resistance as claimed in claim 1 or 2, wherein the gasbag unit is a tubular gasbag curved and provided within the reinforcing shape-forming net, two ends of the tubular gasbag are provided with two gas inlets respectively, and a connecting member is disposed between the gas inlets, and an air-connecting pipe is provided at a gap of the curved gasbag unit.

7. The multiple-layer structure of inflatable device capable of pressure resistance as claimed in claim 1 or 2, wherein the gasbag unit is composed of at least two tubular gasbags connecting with each other and curved and provided within the reinforcing shape-forming, two ends of each o tubular gasbags are provided with both gas inlets respectively, and an anti-dislocation retaining cover is provided between the two tubular gasbags.

8. The multiple-layer structure of inflatable device capable of pressure resistance as claimed in claim 1 or 2, wherein the reinforcing shape-forming net includes an upper net frame, a lower net frame and a plurality of pulling cords connected between the upper net frame and the lower net frame, wherein one of the pulling cords has an end thereof connected between the upper net frame and the lower net frame, and the other end of the pulling cords is connected between the upper net frame and the lower net frame by a releasable fastener.

9. The multiple-layer structure of inflatable device capable of pressure resistance as claimed in claim 8, wherein a hard material board is provided corresponding to an area of the lower net frame, and the hard material board has holes corresponding to the respective pulling cord between the upper net frame and the lower net frame.

10. The multiple-layer structure of inflatable device capable of pressure resistance as claimed in claim 2, wherein the gasbag unit is composed of a connecting cloth and a slit opening for allowing the connecting cloth to pass through the slit opening.

11. The multiple-layer structure of inflatable device capable of pressure resistance as claimed in claim 1, wherein the gasbag unit, which is a transparent cavity gasbag, is provided at an end thereof with a combining hole for allowing a light-emitting unit to be inserted and the other end thereof with a mirror plane corresponding to the combining hole.

12. The multiple-layer structure of inflatable device capable of pressure resistance as claimed in claim 1, wherein the gasbag unit is a transparent conical cavity gasbag, the strengthening and fixing net includes a separating net and a light-reflecting member positioned in a predetermined portion thereof, the gasbag unit is provided over the separating net of the reinforcing shape-forming net, and a hard material base is provided below the separating net of the same.

13. The multiple-layer structure of inflatable device capable of pressure resistance as claimed in claim 12, wherein the gasbag unit further includes a connecting hole formed along a center axis direction for allowing a warning lamp to be inserted.

14. The multiple-layer structure of inflatable device capable of pressure resistance as claimed in claim 1, wherein the gasbag unit is a wind blade shape cavity gasbag for covering on a wind blade device having a rotating shaft and a plurality of wind blades connected with the rotating shaft.

15. The multiple-layer structure of inflatable device capable of pressure resistance as claimed in claim 1 or 2, wherein
the flexible waterproof inner tube is a modeling inner tube and the flexible material of outer tube is made from a chemical fiber (nylon) fabric and/or the fabric threads, and
the reinforcing shape-forming is made from one or the combination of a natural material, a metallic material, a plastic material, a nano material, a fiberglass material and a chemical fiber (nylon) material.

16. A multiple-layer structure of inflatable device capable of pressure resistance, comprising:
a gasbag unit including a gas inlet, a flexible waterproof inner tube fluid connected with the gas inlet, and a flexible material of outer tube covering the flexible waterproof inner tube, wherein a volume of the inflated flexible waterproof inner tube is larger than a volume of the flexible material of outer tube, wherein the gasbag unit is a gas multi-pole structure;
a reinforcing shape-forming net covering the gasbag unit, wherein a volume of the inflated gasbag unit is larger than an area covered by the reinforcing shape-forming net.

17. The multiple-layer structure of inflatable device capable of pressure resistance as claimed in claim 16, wherein
the flexible waterproof inner tube is a modeling inner tube and the flexible material of outer tube is made from a chemical fiber (nylon) fabric and/or the fabric threads.

18. The multiple-layer structure of inflatable device capable of pressure resistance as claimed in claim 8, 12 or 16, wherein the reinforcing shape-forming net is composed of a plurality of partitioning members.

19. The multiple-layer structure of inflatable device capable of pressure resistance as claimed in claim 16, wherein the reinforcing shape-forming net is provided with the holes and a pulling cord passing through the holes, and both ends of the pulling cord are fixed to each other.
